(19) United States
(12) Patent Application Publication
(10) Pub. No.: US 2014/0310678 A1
(43) Pub. Date: Oct. 16, 2014

(54) Systems And Methods For Collaborative Views Of A Hierarchical Software Design

(71) Applicant: Massively Parallel Technologies, Inc., Boulder, CO (US)

(72) Inventor: Kevin D. Howard, Tempe, AZ (US)

(73) Assignee: Massively Parallel Technologies, Inc., Boulder, CO (US)

(21) Appl. No.: 14/253,630

(22) Filed: Apr. 15, 2014

Related U.S. Application Data
(60) Provisional application No. 61/812,127, filed on Apr. 15, 2013.

(51) Int. Cl. G06F 9/44

(52) U.S. Cl. CPC G06F 8/20
USPC 717/100

(57) ABSTRACT

A system, a software product, and a method facilitate collaborative viewing of at least part of a software design. A first view of the at least part of the software design is generated, within a development server. A second view of the at least part of the software design is generated within the development server. Modifications to the at least first part of the software design are received within the development server from a first developer interacting with the first view, and the second view is automatically updated based upon the modifications.

### RELATED APPLICATIONS

This Application claims priority to US Patent Application Ser. No. 61/812,127, titled “Systems and Methods for Collaborative Views of a Hierarchical Software Design,” filed Apr. 15, 2013, and incorporated herein by reference.

### BACKGROUND

Many software-development systems are designated as collaborative. IBM's Rational Rose design system is considered collaborative because it has a collaboration diagram showing the relationships among objects in a design. Cloud9's web-based real-time collaborative programming system allows multiple developers to concurrently edit code. Google's Wave platform combines instant messaging, email, Wikis, and Internet Relay Chat with conference playback and code sharing to form a collaborative software-generation system. No current system allows multiple developers to simultaneously interact with the elements of a hierarchical software design.

Thomas J. McCabe, Sr. (in his paper McCabe T., A Complexity Measure, IEEE Transactions on Software Engineering, December 1976, incorporated herein by reference), discussed linearly independent paths for use in software design.

### SUMMARY OF THE INVENTION

A hierarchical software development system facilitates collaboration at the hierarchical design level, not just at the software code level. This is because code is only decomposed into “methods” or “subroutines” offering limited collaboration opportunities. The MPT hierarchical design decomposes a problem down to “McCabe” linearly independent paths, offering far more opportunities for collaboration.

In one embodiment, a method facilitates collaborative viewing of at least part of a software design. A first view of the at least part of the software design is generated, within a development server. A second view of the at least part of the software design is generated within the development server. Modifications to the at least first part of the software design are received within the development server from a first developer interacting with the first view, and the second view is automatically updated based upon the modifications.

In another embodiment, a system facilitates collaborative viewing of at least part of a software design. The system includes a development server with a processor and a non-transitory memory for storing the software design. The system also includes a collaborator, implemented as machine readable instructions stored within the memory and executed by the processor to (a) generate a first view of the at least part of the software design; (b) generate a second view of the at least part of the software design; (c) receive, from a first developer interacting with the first view, modifications to the at least first part of the software design; and (d) automatically update the second view based upon the modifications.

In another embodiment, a software product has instructions, stored on non-transitory computer-readable media, wherein the instructions, when executed by a computer, perform steps for collaborative viewing of at least part of a software design. The steps include: generating a first view of the at least part of the software design; generating a second view of the at least part of the software design; receiving, from a first developer interacting with the first view, modifications to the at least first part of the software design; and automatically updating the second view based upon the modifications.

### BRIEF DESCRIPTION OF THE FIGURES

FIG. 1 shows one exemplary parallel processing hierarchical software development environment for collaborative views of a hierarchical software design, in an embodiment.

FIG. 1 is a screen shot illustrating creation of a hierarchical software design by a developer, in an embodiment.

FIG. 2 shows an automatically created context level of the hierarchical software design of FIG. 1.

FIG. 3 shows one exemplary non-context level of the hierarchical software design of FIG. 1.

FIG. 4 shows a first screen used by a first developer illustrating changes by the first developer to one decomposition graph of a hierarchical software design before the changes are submitted and a second screen used by a second developer illustrating the same decomposition graph.

FIG. 5 shows one exemplary hierarchical software development environment illustrating a plurality of developers interacting with a server.

FIG. 6 shows collaborative views after the first developer has clicked on the submit button of FIG. 5 to update the software design with second process.

FIG. 7 shows one exemplary smart tag entry screen for defining a smart tag for a particular element of the software design of FIG. 1.

FIG. 8 is a screenshot of one exemplary developer screen displaying one exemplary decomposition graph with a new message indicator displayed against element of the software design of FIG. 1.

FIG. 9 shows one exemplary message display that is generated when a viewer selects (e.g., clicks on using a mouse) the message indicator of FIG. 8.

### DETAILED DESCRIPTION OF THE EMBODIMENTS

### Hierarchical Design

Within an online hierarchical software development environment, hierarchical software designs are called high-level designs or decomposition graphs. The top-most level of the design is called the context level, and is automatically created when a project is created within the online hierarchical software development environment.

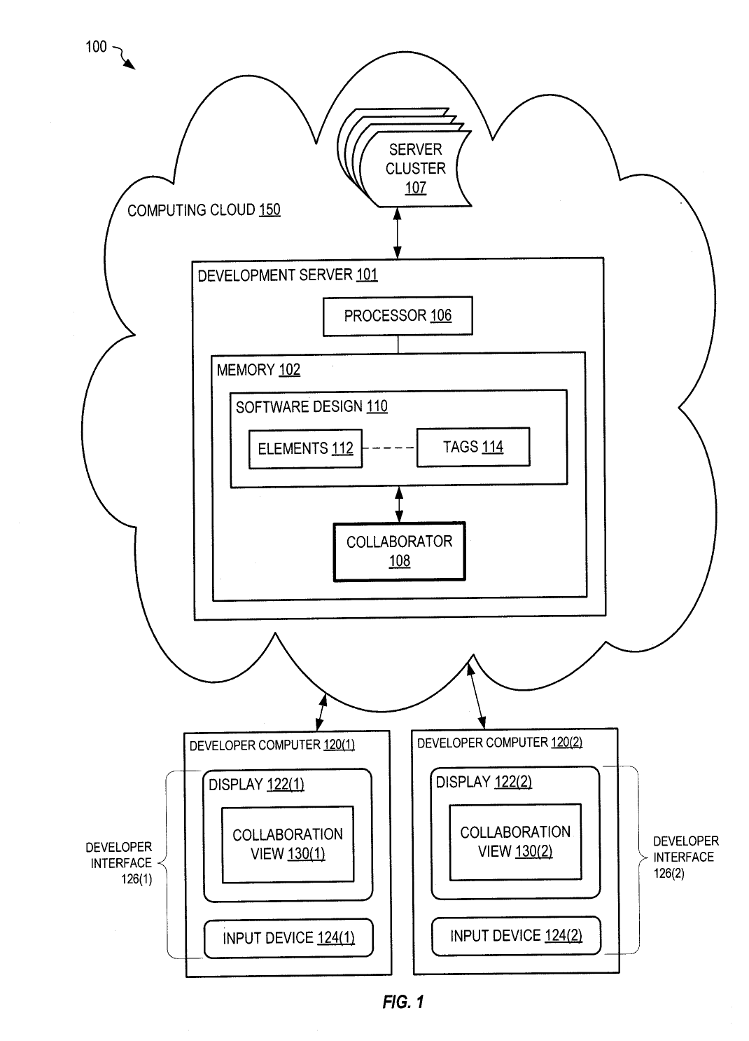

FIG. 1 shows one exemplary parallel processing hierarchical software development environment 100. A development server 101 provides access to a server cluster 107 of processing nodes. Development server 101 includes a memory 102 (e.g., volatile - RAM, non-volatile ROM, Flash, magnetic media, optical media, a database, and one or more data structures) and a processor 106. As shown in FIG. 1, development server 101 and server cluster 107 may operate within a computing cloud 150, wherein cloud 150 represents computer network connectivity between development server 101, server cluster 107 and one or more development computers 120. Cloud 150 may at least in part represent the Internet. A first developer uses a developer computer 120(1) to access (e.g., via the Internet and/or other computer network technology) development server 101, wherein the first developer is provided a developer interface 126(1) using developer computer 120(1). Developer interface 126(1) is for example implemented using a display 122(1) and an input device 124(1) of developer computer 120(1) as controlled by a browser or other similar software running on developer computer 120.

Similarly, a second developer uses a developer computer 120(2) to access (e.g., via the Internet and/or other computer network technology) development server 101, wherein the second developer is provided a developer interface 126(2) using developer computer 120(2). Developer interface 126(2) is for example implemented using a display 122(2) and an input device 124(2) of developer computer 120(2).

The first and second developers interact with developer interface 126 to access and manipulate a software design 110 within development server 101. Development server 101 also includes a collaborator 108 that implements collaboration between the first and second developers using a collaboration view 130. For example, collaboration view 130(1) is displayed on display 122(1) and collaboration view 130(2) is displayed on display 122(2) and each operates to provide a view of at least a portion of software design 110. Where developers each operate computers 120(1) and (2) to view the same portion of software design 110, collaboration view 130(1) is similar to collaboration view 130(2).

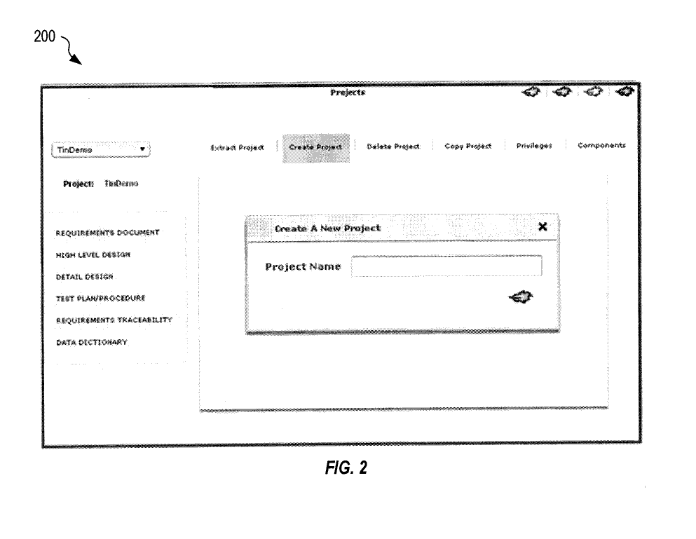

FIG. 2 is a screen shot 200 illustrating creation of a new project within development server 101 of FIG. 1 to create software design 110. For example, the first developer uses developer computer 120(1) to interactively create a new project for development of software design 110.

FIG. 3 shows a context level 300 of software design 110 of FIG. 1 that is automatically created. For example, context level 300 is created automatically for software design 110 when the new project of FIG. 2 is created. In particular, context level 300 has a terminator 302 with an initial connection 304 to a process 306.

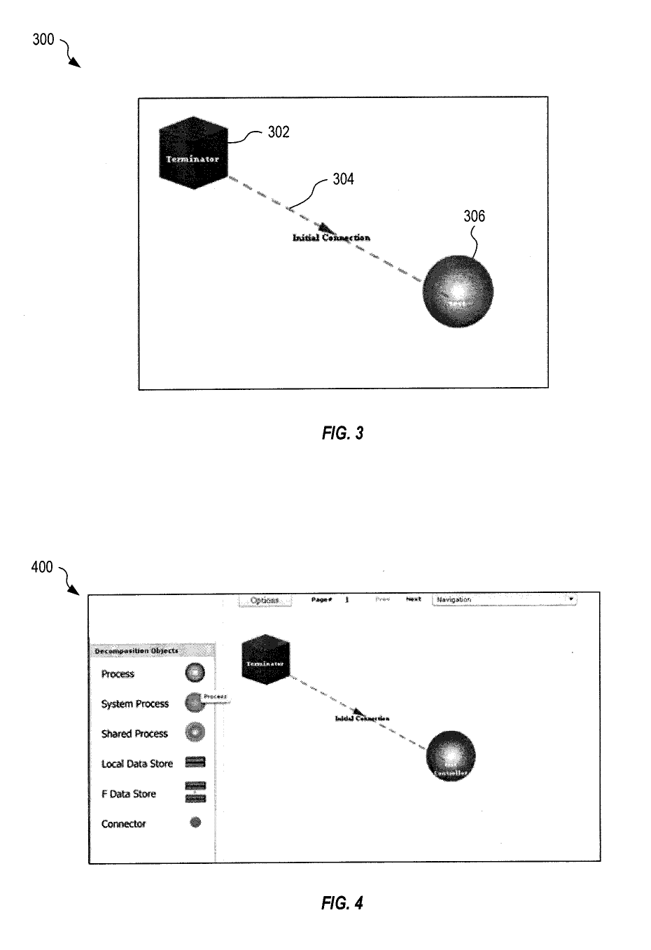

FIG. 4 shows a screen shot 400 illustrating one exemplary non-context level 404 of software design 110 of FIG. 1, as interactively created by the first developer using developer computer 120(1) for example.

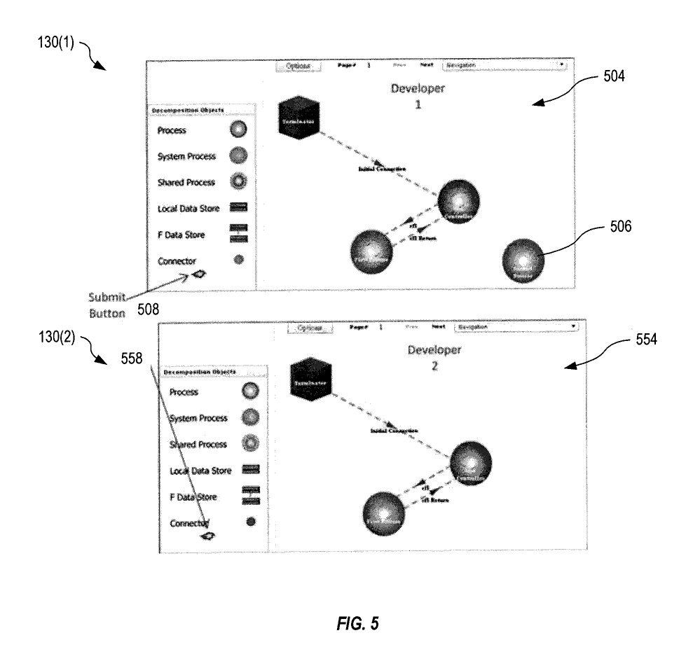

FIG. 5 shows a first collaborative view 130(1), as displayed on developer computer 120(1) for example, illustrating a decomposition graph 504 that is part of software design 110. Within view 130(1), the first developer, interacting with development sever 101 via development computer 120(1), adds a second process 506 to decomposition graph 504. FIG. 5 also shows a second collaborative view 130(2), as displayed on developer computer 120(2) for example, illustrating a decomposition graph 554 of software design 110. Decomposition graph 554 represents the same portion of software design 110 as shown in decomposition graph 504, but does not include second process 506.

Although collaborative views 130 show decomposition graphs 504, 554, other representations of software design 110 may be collaboratively viewed by two or more developers without departing from the scope hereof.

Where multiple developers have shared access to software design 110, one or more of these developers may modify a portion of the software design on their local development computer 120. However, software design 110 is not updated by any local modification until that local modification is submitted by the developer. Thus, in the example of FIG. 5, second process 506 is not displayed within collaborative view 130(2) because the local modification of adding process 506 by the first developer is not yet submitted to software design 110.

Submission of local modifications occurs when the first developer clicks on submit button 508 for example. In an alternative embodiment, development sever 101 is configured to automatically transmit modifications as they are made by one developer 104 to all other developers 104 viewing the same portion of the software design without requiring the developer to click on submit button 508.

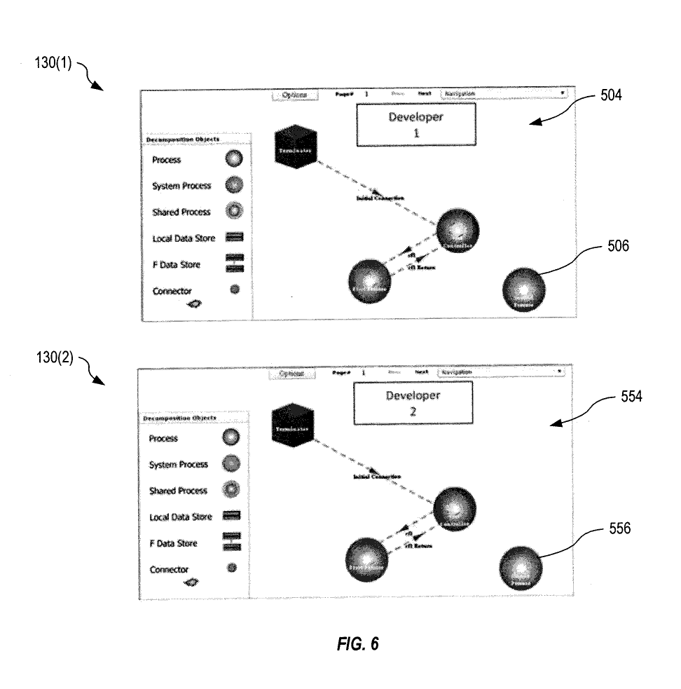

FIG. 6 continues the example of FIG. 5 and shows collaborative views 130(1) and 130(2) after the local modification of adding second process 506 have been submitted (e.g., by the first developer clicking on submit button 508) to software design 110. In particular, collaborative view 130(2) is updated, when (or shortly after) submit button 508 is clicked by the first developer, to display a second process 556 within decomposition graph 554. Thus, decomposition graphs 504 and 554 become substantially the same and show the same portion of software design 110.

Collaborative views 130 allow true real-time interactive collaboration of at least a portion of software design 110, where such interactive collaboration is superior to both (a) separate designs that require a reconciliation step, and (b) design collaboration using separate communication, such as via Instant Messaging (IM)/emails/voice. Since design is a higher level of conception than software code, these collaborative views 130 offer the ability for developers to work on high-order problems of software design 110 prior to becoming “bogged down” in development of software code.

To further enhance collaboration, system 100 uses smart tags 114 within software design 110. Smart tag 114 is attached to a design element 112 (e.g., a design object) of software design 110, and has an associated message indicator that is visible only to intended viewer(s) and indicates a message text is available for reading. Smart tags 114 allow for time-shifted communication of information that is directly associated with particular design elements 112 for example.

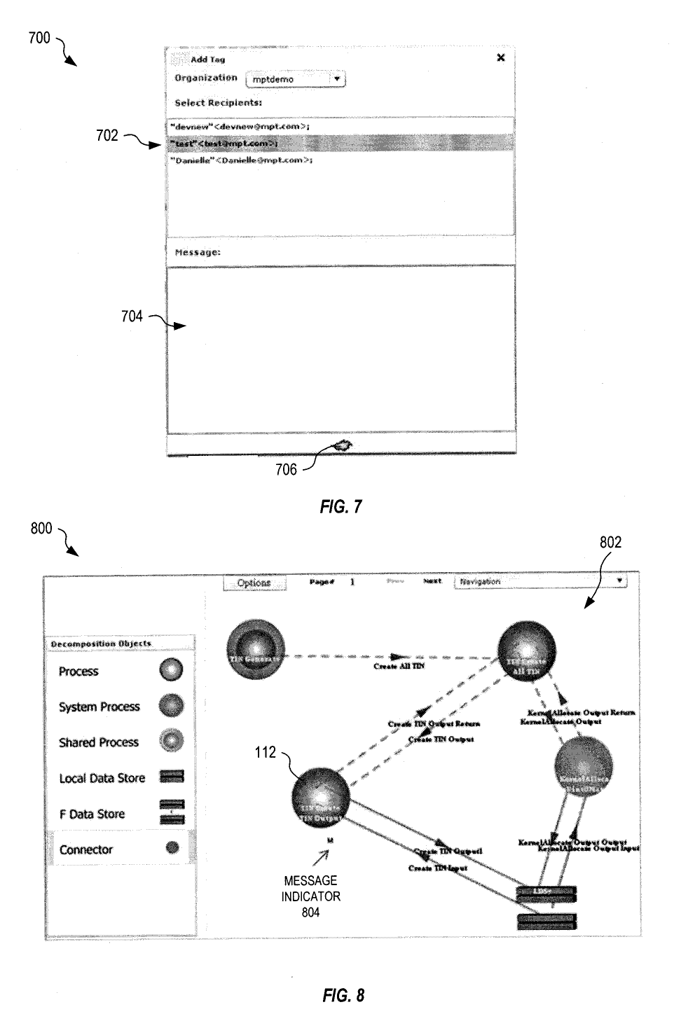

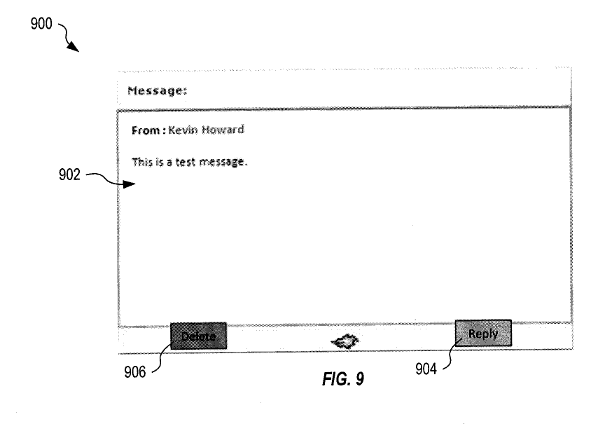

FIG. 7 shows one exemplary smart tag entry screen 700 for defining a smart tag 114 for a particular element 112 of software design 110 of FIG. 1. FIG. 8 is a screen shot 800 of one exemplary developer screen displaying one exemplary decomposition graph 802 of software design 110 with a new message indicator 804 displayed against element 112 of software design 110. FIGS. 7 and 8 are best viewed together with the following description.

On tag entry screen 700, a developer (a) enters one or more recipient(s) 702 for smart tag 114 that define other participants (e.g., developers) that may view smart tag 114, (b) enters text of a message (i.e., the information associated with smart tag 114 and/or element 112) within a message area 704, and then (c) selects a send button 706. System 100 then associates smart tag 114 with the particular element 112 of design 110. When the particular element 112 is viewed by the other participants listed within recipients 702 of smart tag 114, a message indicator 804 is displayed proximate the display of the particular element 112.

FIG. 9 shows one exemplary message display 900 that is generated and displayed (e.g., on display 122 of developer computer 120) when a viewer (e.g., a developer) selects (e.g., clicks on using a mouse) message indicator 804 of FIG. 8. Display 900 has a message area 902 wherein information entered within message area 704 for smart tag 114 is displayed for example. Once the message text is viewed, message indicator 804 disappears for that recipient 702. Thus, message indicator 804 indicates unread messages for that recipient 702.

Display 900 also includes a reply button 904 that allows the viewer to reply to the message, and a delete button that allows the viewer to delete the message. System 100 thereby provides selective messaging capability, including reply and delete functionality, with each smart tag 114. In one example of operation, the recipient 702 first selects the “From” line, then selects Reply button 904, and then enters a reply to the message into a popup screen similar to smart tag entry screen 700. Similarly, one or more recipients 702 may be removed from the message when replying, such as by the recipient 702 using the delete button 906 after selecting a recipient 702 within the “From” line.

### Combinations of Features

Although particular combinations of features are recited in the claims and/or disclosed in the specification, these combinations are not intended to limit the disclosure of the embodiments. Many of these features may be combined in ways not specifically recited in the claims and/or disclosed in the specification. Features of each dependent claim may combine together with other claims in the set, even where claims are not directly linked. For example:
(a) A method for collaborative viewing of at least part of a software design, includes: generating, within a development server, a first view of the at least part of the software design; generating, within the development server, a second view of the at least part of the software design; receiving, within the development server and from a first developer interacting with the first view, modifications to the at least first part of the software design; and automatically updating the second view based upon the modifications.
(b) In the method of (a), the first view is displayed to the first developer and the second view is displayed to a second developer.
(c) In the method of (b), the first and second views are generated concurrently and where the first and second developers interact with the respective first and second views simultaneously and in real-time.
(d) In any of the methods of (a)-(c), automatically updating the second view in response to the first developer selecting a submit button.
(e) In any of the methods of (a)-(d), the method further including: receiving, within the development server, a message text from the first developer; receiving, within the development server, an indication of at least one recipient of the message text; receiving, within the development server, an indication of one element of the software design; generating, within the development server, a smart tag containing the message text and the identity of the at least one recipient; associating the smart tag with the one element; and displaying a message indicator adjacent a representation of the one element in the second view; wherein the second view is generated for the identified recipient.
(f) In any of the methods of (a)-(e), the method further including displaying the message text within the second view in response to the identified recipient selecting the message indicator.
(g) In any of the methods of (a)-(f), the method further including inhibiting display of the message indicator when the message text has been viewed by the identified recipient.
(h) In a system for collaborative viewing of at least part of a software design, the system including: a development server having a processor and a non-transitory memory storing the software design; and a collaborator, implemented as machine readable instructions stored within the memory and executed by the processor to perform the steps of: generating a first view of the at least part of the software design; generating a second view of the at least part of the software design; receiving, from a first developer interacting with the first view, modifications to the at least first part of the software design; and automatically updating the second view based upon the modifications.
(i) In the system of (h), the first view is displayed to the first developer and the second view is displayed to a second developer.
(j) In the system of (i), the first and second views are generated concurrently and wherein the first and second developers interact with the respective first and second views simultaneously and in real-time.
(k) In any of the systems of (h) through (j), automatically updating the second view in response to the first developer selecting a submit button.
(l) In any of the systems of (h) through (k), the collaborator further comprising instructions stored within the memory and executed by the processor for performing the steps of: receiving, within the development server, a message text from the first developer; receiving, within the development server, an indication of at least one recipient of the message text; receiving, within the development server, an indication of one element of the software design; generating, within the development server, a smart tag containing the message text and the identity of the at least one recipient; associating the smart tag with the one element; and displaying a message indicator adjacent a representation of the one element in the second view; wherein the second view is generated for the identified recipient.
(m) In any of the systems of (h) through (l), the collaborator further comprising instructions stored within the memory and executed by the processor for performing the step of displaying the message text within the second view in response to the identified recipient selecting the message indicator.
(n) In any of the systems of (h) through (m), the collaborator further comprising instructions stored within the memory and executed by the processor for inhibiting display of the message indicator when the message text has been viewed by the identified recipient.
(o) In a software product having instructions, stored on non-transitory computer-readable media, wherein the instructions, when executed by a computer, perform steps for collaborative viewing of at least part of a software design, including: instructions for generating a first view of the at least part of the software design; instructions for generating a second view of the at least part of the software design; instructions for receiving, from a first developer interacting with the first view, modifications to the at least first part of the software design; and instructions for automatically updating the second view based upon the modifications.
(p) In the software product of (o), the first view is displayed to the first developer and the second view is displayed to a second developer.
(q) In the software product of (p), the first and second views are generated concurrently and wherein the first and second developers interact with the respective first and second views simultaneously and in real-time.
(r) In any of the software products of (o)-(q), the software product including instructions for automatically updating the second view in response to the first developer selecting a submit button.
(s) In any of the software products of (o)-(r), the software product further including: instructions for receiving, within the development server, a message text from the first developer; instructions for receiving, within the development server, an indication of at least one recipient of the message text; instructions for receiving, within the development server, an indication of one element of the software design; instructions for generating, within the development server, a smart tag containing the message text and the identity of the at least one recipient; instructions for associating the smart tag with the one element; and instructions for displaying a message indicator adjacent a representation of the one element in the second view; wherein the second view is generated for the identified recipient.
(t) In any of the software products of (o)-(s), the software product further including instructions for displaying the message text within the second view in response to the identified recipient selecting the message indicator.
(u) In any of the software products of (o)-(t), the software product further including instructions for inhibiting display of the message indicator when the message text has been viewed by the identified recipient.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A method for collaborative viewing of at least part of a software design, comprising:
generating, within a development server, a first view of the at least part of the software design;
generating, within the development server, a second view of the at least part of the software design;
receiving, within the development server and from a first developer interacting with the first view, modifications to the at least first part of the software design; and
automatically updating the second view based upon the modifications.

2. The method of claim 1, wherein the first view is displayed to the first developer and the second view is displayed to a second developer.

3. The method of claim 2, wherein the first and second views are generated concurrently and wherein the first and second developers interact with the respective first and second views simultaneously and in real-time.

4. The method of claim 1, the step of automatically updating comprising automatically updating the second view in response to the first developer selecting a submit button.

5. The method of claim 1, further comprising:
receiving, within the development server, a message text from the first developer;
receiving, within the development server, an indication of at least one recipient of the message text;
receiving, within the development server, an indication of one element of the software design;
generating, within the development server, a smart tag containing the message text and the identity of the at least one recipient;
associating the smart tag with the one element; and
displaying a message indicator adjacent a representation of the one element in the second view; wherein the second view is generated for the identified recipient.

6. The method of claim 5, further comprising displaying the message text within the second view in response to the identified recipient selecting the message indicator.

7. The method of claim 5, further comprising inhibiting display of the message indicator when the message text has been viewed by the identified recipient.

8. A system for collaborative viewing of at least part of a software design, comprising:
a development server having a processor and a non-transitory memory storing the software design; and
a collaborator, implemented as machine readable instructions stored within the memory and executed by the processor to perform the steps of:
generating a first view of the at least part of the software design;
generating a second view of the at least part of the software design;
receiving, from a first developer interacting with the first view, modifications to the at least first part of the software design; and
automatically updating the second view based upon the modifications.

9. The system of claim 8, wherein the first view is displayed to the first developer and the second view is displayed to a second developer.

10. The system of claim 9, wherein the first and second views are generated concurrently and wherein the first and second developers interact with the respective first and second views simultaneously and in real-time.

11. The system of claim 8, the step of automatically updating comprising automatically updating the second view in response to the first developer selecting a submit button.

12. The system of claim 8, the collaborator further comprising instructions stored within the memory and executed by the processor for performing the steps of:
receiving, within the development server, a message text from the first developer;
receiving, within the development server, an indication of at least one recipient of the message text;
receiving, within the development server, an indication of one element of the software design;
generating, within the development server, a smart tag containing the message text and the identity of the at least one recipient;
associating the smart tag with the one element; and
displaying a message indicator adjacent a representation of the one element in the second view; wherein the second view is generated for the identified recipient.

13. The system of claim 12, the collaborator further comprising instructions stored within the memory and executed by the processor for performing the step of displaying the message text within the second view in response to the identified recipient selecting the message indicator.

14. The system of claim 12, the collaborator further comprising instructions stored within the memory and executed by the processor for inhibiting display of the message indicator when the message text has been viewed by the identified recipient.

15. A software product comprising instructions, stored on non-transitory computer-readable media, wherein the instructions, when executed by a computer, perform steps for collaborative viewing of at least part of a software design, comprising:
instructions for generating a first view of the at least part of the software design;
instructions for generating a second view of the at least part of the software design;
instructions for receiving, from a first developer interacting with the first view, modifications to the at least first part of the software design; and
instructions for automatically updating the second view based upon the modifications.

16. The software product of claim 15, wherein the first view is displayed to the first developer and the second view is displayed to a second developer.

17. The software product of claim 16, wherein the first and second views are generated concurrently and wherein the first and second developers interact with the respective first and second views simultaneously and in real-time.

18. The software product of claim 15, the instructions for automatically updating comprising instructions for automatically updating the second view in response to the first developer selecting a submit button.

19. The software product of claim 15, further comprising:
instructions for receiving, within the development server, a message text from the first developer;
instructions for receiving, within the development server, an indication of at least one recipient of the message text;
instructions for receiving, within the development server, an indication of one element of the software design;
instructions for generating, within the development server, a smart tag containing the message text and the identity of the at least one recipient;
instructions for associating the smart tag with the one element; and
instructions for displaying a message indicator adjacent a representation of the one element in the second view; wherein the second view is generated for the identified recipient.

20. The software product of claim 19, further comprising instructions for displaying the message text within the second view in response to the identified recipient selecting the message indicator.

21. The software product of claim 19, further comprising instructions for inhibiting display of the message indicator when the message text has been viewed by the identified recipient.
